(19) United States
(12) Patent Application Publication
(10) Pub. No.: US 2023/0152155 A1
(43) Pub. Date: May 18, 2023

(54) METHOD AND SYSTEM FOR SPECTRUM MATCHING FOR HYPERSPECTRAL AND MULTISPECTRAL DATA

(71) Applicant: Tata Consultancy Services Limited, Mumbai (IN)

(72) Inventors: SHAILESH SHANKAR DESHPANDE, Pune (IN); MANISH KAUSIK HARI BASKAR, Bangalore (IN); BALAMURALIDHAR PURUSHOTHAMAN, Bangalore (IN)

(73) Assignee: Tata Consultancy Services Limited, Mumbai (IN)

(21) Appl. No.: 18/048,055

(22) Filed: Oct. 20, 2022

(30) Foreign Application Priority Data
Nov. 12, 2021 (IN) 202121052028

(51) Int. Cl. G01J 3/28

(52) U.S. Cl. CPC G01J 3/2823; G01J 2003/2826

(57) ABSTRACT

This disclosure provides a method and system for spectrum matching for hyperspectral and multispectral data. Conventional methods using geometric or statistical distance measures for spectral matching considers two spectra having equal length or having large amplitude difference. These methods do not consider amplitude difference in the spectra or spectra with unequal lengths. Embodiments of the present disclosure is formulated as a measurement of transformation required for converting a target spectrum to a reference spectrum or vice versa. The method computes a transformation cost between the two spectra for spectral matching. The transformation cost is globally optimized to obtain an optimal transformation cost which represents the optimal spectrum matching of the target spectrum with the reference spectrum.

### PRIORITY CLAIM

This U.S. patent application claims priority under 35 U.S.C. § 119 to: Indian Patent Application No. 202121052028, filed on Nov. 12, 2021. The entire contents of the aforementioned application are incorporated herein by reference.

### TECHNICAL FIELD

The disclosure herein generally relates to the field of spectral matching and more particularly, to a method and system for spectrum matching for hyperspectral and multispectral data.

### BACKGROUND

In hyperspectral imaging, hyperspectral data is collected with a large number of narrow bands, as opposed to RGB data (which is collected with three broad bands) or multispectral data (which is collected with more than three broad bands). Because of the narrow band data collection in hyperspectral imaging (commonly less than or equal to ten nano meters), the detailed interaction between a material and the solar energy is available. This interaction is recorded as an amount of energy reflected by each wavelength/band (indicating reflectance recorded over a certain range). Hypothetically, reflection and absorption of the solar energy at each wavelength (over a wide wavelength range) by the given material is unique and hence the material is identified by such a unique signature. This is not available in RGB imaging and/or multispectral imaging because of the broad band data collection.

There are several remote sensing techniques for detecting a target material. One of the most common strategies is to record the signature of reference materials and create a library. The signature of the target material (material to be detected, whose signature is available from any source) is then matched with the references in the library. The match can be found for a specific diagnostic absorption or reflectance or for entire spectrum of the target material and reference material. If there are no prominent diagnostic absorptions or reflectance in the spectrum then the entire spectrum is matched. The entire spectrum match is used in hyperspectral image classification (segmentation) procedure. In this classification process a target image pixel is matched with the library for labelling the same. The target image pixel is labelled with the label of the reference material having closest match with the target image pixel. The procedure is repeated for every target image pixel in the target image for segmenting. The spectral matching is also used in deep learning classification as well. A match score between the target image and the reference material is used for measuring reconstruction loss or any other similar loss for optimizing weights of the deep learning network. The loss function corresponding to the above said losses is desired, in addition to loss because of labelling error, to generalize the deep learning model well. The matching is relevant in the other procedures as well wherein exclusive label is not required yet matching between two spectra is essential. For example, the process of clustering is performed using the match score (or similarity measure or distance measure) between two spectra. The pixels are grouped based on the similarity of the pixel, with the pixel (or some hypothetical pixel) representing cluster center.

There are many spectral matching methods such as cosine measure or spectral angle between two spectra, L1 norm corresponds to band wise difference, L2 norm corresponds to Euclidian distance in case the spectra are represented as a real-valued vector. If the spectra are converted to binary representation, then hamming distance is used. Most of these spectral matching methods consider geometric or statistical distances and each one has advantages and disadvantages. For example, if the two spectra are having similar shapes, cosine measure does not account for the amplitude difference in the spectra. For large statistically significant amplitude difference of the spectra, the cosine measure is same. This kind of measures considers the spectrum of the target material as an ‘n’ dimensional vector where ‘n’ equals number of bands. Furthermore, these distances are defined over spectra of equal lengths. There are situations wherein the spectra might not be of equal lengths. There might be different number of bands in the same wavelength range because of differences in spectral-resolution or situation demands matching between multispectral and hyperspectral signatures. For example, when a multispectral spectrum is to be matched with the one in the hyperspectral library.

### SUMMARY

Embodiments of the present disclosure present technological improvements as solutions to one or more of the above-mentioned technical problems recognized by the inventors in conventional systems.

For example, in one embodiment, a method for spectrum matching for hyperspectral and multispectral data is provided. The method includes: receiving a target spectrum of a target object for performing an optimal spectrum matching with a reference spectrum, wherein the target spectrum comprises a first set of primitives and the reference spectrum comprises a second set of primitives represented in a two-dimensional space; transforming each primitive in the first set of primitives of the target spectrum to at least one primitive in the second set of primitives of the reference spectrum using at least one of a first transformation method, a second transformation method and a third transformation method to obtain a set of transformations, wherein each transformation in the set of transformations incurs a transformation cost; obtaining a set of optimal transformations of the first set of primitives to the second set of primitives by optimizing the set of transformations; obtaining a set of global transformation costs by taking the sum of transformation cost corresponding to each optimal transformation of the set of optimal transformations; and obtaining an optimal transformation cost by optimizing the set of global transformation costs using an optimization technique, wherein the optimal transformation cost represents the optimal spectrum matching of the target spectrum with the reference spectrum.

In another aspect, a system for spectrum matching for hyperspectral and multispectral data is provided. The system comprises memory storing instructions; one or more communication interfaces; and one or more hardware processors coupled to the memory via the one or more communication interfaces, wherein the one or more hardware processors are configured by the instructions to receive a target spectrum of a target object for performing an optimal spectrum matching with a reference spectrum, wherein the target spectrum comprises a first set of primitives and the reference spectrum comprises a second set of primitives represented in a two-dimensional space; transform each primitive in the first set of primitives of the target spectrum to at least one primitive in the second set of primitives of the reference spectrum using at least one of a first transformation method, a second transformation method and a third transformation method to obtain a set of transformations, wherein each transformation in the set of transformations incurs a transformation cost; obtain a set of optimal transformations of the first set of primitives to the second set of primitives by optimizing the set of transformations; obtain a set of global transformation costs by taking the sum of transformation cost corresponding to each optimal transformation of the set of optimal transformations; and obtain an optimal transformation cost by optimizing the set of global transformation costs using an optimization technique, wherein the optimal transformation cost represents the optimal spectrum matching of the target spectrum with the reference spectrum.

In an embodiment, wherein the target spectrum and the reference spectrum are at least one of a hyperspectral spectrum or a multispectral spectrum.

In an embodiment, wherein the first transformation method corresponds to an edit distance based method based on a distance measured between the first set of primitives and the second set of primitives.

In an embodiment, wherein the second transformation method corresponds to a Hungarian based method based on x and y dimension distance measure between the first set of primitives and the second set of primitives.

In an embodiment, wherein the third transformation method corresponds to a piece-wise angular distance method based on angular difference and length difference between the first set of primitives and the second set of primitives.

In an embodiment, wherein the transformation cost corresponds to one or more of (i) translation of a primitive in x and y dimensions (ii) deletion of the primitive and (iii) insertion of the primitive.

In yet another aspect, a non-transitory computer readable medium for spectrum matching for hyperspectral and multispectral data is provided by receiving a target spectrum of a target object for performing an optimal spectrum matching with a reference spectrum, wherein the target spectrum comprises a first set of primitives and the reference spectrum comprises a second set of primitives represented in a two-dimensional space; transforming each primitive in the first set of primitives of the target spectrum to at least one primitive in the second set of primitives of the reference spectrum using at least one of a first transformation method, a second transformation method and a third transformation method to obtain a set of transformations, wherein each transformation in the set of transformations incurs a transformation cost; obtaining a set of optimal transformations of the first set of primitives to the second set of primitives by optimizing the set of transformations; obtaining a set of global transformation costs by taking the sum of transformation cost corresponding to each optimal transformation of the set of optimal transformations; and obtaining an optimal transformation cost by optimizing the set of global transformation costs using an optimization technique, wherein the optimal transformation cost represents the optimal spectrum matching of the target spectrum with the reference spectrum.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary block diagram of a system for spectrum matching for hyperspectral and multispectral data, in accordance with some embodiments of the present disclosure

FIG. 2 is an exemplary flow diagram illustrating a method for spectrum matching for hyperspectral and multispectral data according to some embodiments of the present disclosure.

FIG. 3A depicts a graphical representation of an example of spectral signatures in line graph according to some embodiments of the present disclosure.

FIG. 3B depicts a graphical representation of an example of spectral signatures in bar chart according to some embodiments of the present disclosure.

FIG. 4 depicts a graphical representation of an example showing transformation steps for spectrum matching according to some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

The embodiments herein provide a method and system for spectrum matching for hyperspectral and multispectral data. The disclosed method explains spectrum matching as a measurement of transformation required for converting a target spectrum to a reference spectrum in a library or vice versa. Each primitive in a set of primitives of the target spectrum is transformed to the primitive of the reference spectrum. Each transformation has a cost associated with it. The total cost of transformation is taken as a distance between the two spectra. The disclosed method performs spectral matching based on a distance between the two spectra which reflect the shape difference between the two spectra in two-dimensional space (wavelength and reflectance).

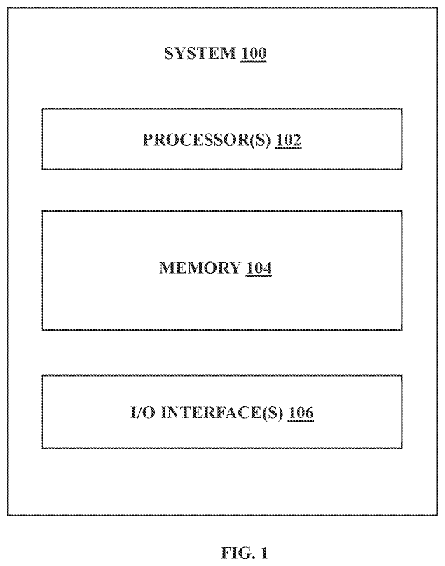

Referring now to the drawings, and more particularly to FIG. 1 through FIG. 4, where similar reference characters denote corresponding features consistently throughout the figures, there are shown preferred embodiments and these embodiments are described in the context of the following exemplary system and/or method.

FIG. 1 illustrates a system 100 for spectrum matching for hyperspectral and multispectral data. In an embodiment, the system 100 includes one or more processors 102, communication interface device(s) or input/output (I/O) interface(s) 106, and one or more data storage devices or memory 104 operatively coupled to the one or more processors 102. The one or more processors 102 that are hardware processors can be implemented as one or more microprocessors, microcomputers, microcontrollers, digital signal processors, central processing units, state machines, graphics controllers, logic circuitries, and/or any devices that manipulate signals based on operational instructions. Among other capabilities, the processor(s) are configured to fetch and execute computer-readable instructions stored in the memory. In the context of the present disclosure, the expressions ‘processors’ and ‘hardware processors’ may be used interchangeably. In an embodiment, the system 100 can be implemented in a variety of computing systems, such as laptop computers, notebooks, hand-held devices, workstations, mainframe computers, servers, a network cloud and the like.

The I/O interface (s) 106 may include a variety of software and hardware interfaces, for example, a web interface, a graphical user interface, and the like and can facilitate multiple communications within a wide variety of networks and protocol types, including wired networks, for example, LAN, cable, etc., and wireless networks, such as WLAN, cellular, or satellite. In an embodiment, the I/O interface(s) can include one or more ports for connecting a number of devices to one another or to another server.

The memory 104 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

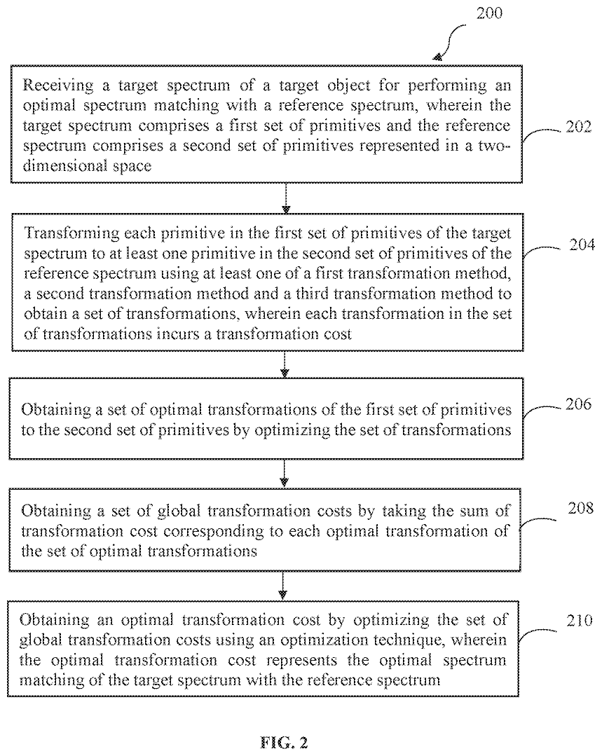

FIG. 2 is an exemplary flow diagram illustrating a method for spectrum matching for hyperspectral and multispectral data according to some embodiments of the present disclosure. The steps of the method 200 of the present disclosure will now be explained with reference to the components of the system 100.

In an embodiment of the present disclosure, the one or more processors 102 are configured to receive at step 202, a target spectrum of a target object for performing an optimal spectrum matching with a reference spectrum, wherein the target spectrum comprises a first set of primitives and the reference spectrum comprises a second set of primitives represented in a two-dimensional space. The x-axis and y-axis in two-dimensional space correspond to wavelength and reflectance respectively. In an embodiment, the target spectrum can be hyperspectral or multispectral spectrum and the reference spectrum is hyperspectral spectrum, however in some cases the reference spectrum can be multispectral spectrum also. The target spectrum can be received as a single spectrum or as a collection of spectra (collection of spectra in image or non-image format). The set of primitives of the target spectrum and reference spectrum can be curves or a set of points.

In an embodiment of the present disclosure, the one or more processors 102 are configured to transform at step 204, each primitive in the first set of primitives of the target spectrum to at least one primitive in the second set of primitives of the reference spectrum using at least one of a first transformation method, a second transformation method and a third transformation method to obtain a set of transformations, wherein each transformation in the set of transformations incurs a transformation cost. In an embodiment, the transformation method is chosen based on sensitivity measure of the three transformation methods. In general, sensitivity is a measure of changes in the distance per unit perturbations in an original spectrum. White noise is added to the original spectra and then a match is measured between the original and changed spectra. This distance indicates the increase in the distance because of the disturbances added in the original spectrum (as the distance with self is zero). Further, the distance is divided by the total perturbations added. Higher the sensitivity better is the method for calculating match score. Table 1 provides a comparative assessment of sensitivity of various prior distance measures with the disclosed methods for hyperspectral signatures.

TABLE 1

| Method | Sensitivity |
|---|---|
| Euclidean | 18.86 |
| Cosine | 0.74 |
| Edit distance method | 280.63 |
| Hungarian based | 287.80 |
| method | |
| Piece-wise angle | 255.04 |
| method | |
| Frechet distance | 18.86 |
| L1-Norm | 287.80 |
| Hamming distance | 1430.0 |

In another embodiment, the method for transformation for spectral matching can also be selected based on other attributes as well such as computational complexity of the method, domain knowledge (encoding the expert knowledge in form of rules and using rule based or case based system for selecting the method), meta empirical or analytical method or ensemble methods (voting or taking weighted summation of distances from all methods and weightage assigned to outcome of each method wherein weightage is assigned by experts or calculated automatically by internal properties of the method). The first transformation method corresponds to edit distance method, the second transformation method corresponds to Hungarian method and the third transformation method corresponds to piece-wise angle and length distance method. The explanation and algorithm for the first, second and third transformation methods are provided further after step 206. The steps of the algorithm for first, second and third transformation methods provided further includes the step 206 of the method 200.

In an embodiment of the present disclosure, the one or more processors 102 are configured to obtain at step 206, a set of optimal transformations of the first set of primitives to the second set of primitives by optimizing the set of transformations.

According to an embodiment of the disclosure, the steps for the edit distance method are provided below:

1.Create a first matrix for pairs from target spectrum primitives and reference spectrum primitives.
2. Starting from left to right and starting at first primitive of the target spectrum calculate the three distances with the mapped/paired primitive on reference spectrum. The three distance operations are insertion, deletion and substitution. If the target spectrum and the reference spectrum are of equal length, insertion and deletion operation is not needed. Minimum of the three distances is chosen for finding the total transformation cost and cost associated with the operation is added.
3. Repeat the operation for all the paired primitives and sum up the cost for selected operations for each paired transformation to obtain the total transformation cost.

According to an embodiment of the disclosure, the steps for the Hungarian based method are provided below:

1. Create a second matrix of pairs of the primitives from the target spectrum and the reference spectrum.
2. In this case the primitive from target spectrum can be mapped or transformed to any other primitive in the reference spectrum. A cost is associate for each such transformation of paired primitives.
3. Calculate the cost of transformation for each pair. The cost for a transformation for a pair is: weighted x and y scalar difference (Δx and Δy). By end of this step a matrix with all possible transformation and their cost would be ready. Thus, for example, assuming equal length spectrums of n bands there would be n×n pairs of assignments.

According to an embodiment of the disclosure, the steps for the piece-wise angle and length distance method are given below:

1. Calculate an angular difference and a length difference between corresponding arcs of the target spectrum and the reference spectrum to generate an arc score wherein the target spectrum and the reference spectrum are represented by two dimensions wavelength and reflectance values.
2. Repeat the step 1 for every corresponding arc in the target and the reference spectrum.
3. Add the arc scores corresponding to all arcs to get the final matching score.

In an embodiment another variant for the piece-wise angle and length method is provided as follows. The n dimensional vector can be viewed from n−1 two dimensional directions, three dimensional directions and so on. For example, a point in XYZ dimensions can be orthographically projected to XY, YZ, or XZ plane or can be viewed from the direction which is perpendicular to the plane. Such a pair of dimensions in sequence can represent vector in subspace. The cosine for such a projected vector between the reference and the target spectrum is calculated for each two dimensions in sequence and then added up to give the total distance. For example, if a spectrum A has 8 bands named as band a1, a2, a3, a4 and so on. And spectrum B has 8 bands b1, b2, b3, b4 and so on. Then vector in subspace 1-2 for target and reference is considered. Its cosine is calculated that is cosine between vector (a1, b1) and vector (b1, b2). Same procedure is repeated for all the ordered pairs such as (a2,a3) and (b2,b2) and so on and the cosine in for each such pair is aggregated to give the total similarity between the two spectra.

The pseudo code for the edit distance method is provided below Inputs:

Band_Wavelengths, Spectrum A, Spectrum B

### Initialization:

dist: =0

dp_matrix:=empty_matrix(shape=(num_of_bands, num_of_bands))

### Algorithm:

```
  //Base cases for DP
  for each i in enumerate(Band_Wavelengths):
    dp_matrix[i,0] = i
    dp_matrix[0,i] = i
  for each i in {enumerate(Band_Wavelengths)}−{0}:
    for each j in {enumerate(Band_wavelength)}−{0}:
      //Both positions are same
      If A[j]==B[i]:
      dp_mat[i,j]=dp_matrix[i−1,j−1]
      //Take the minimum of insertion, deletion or substi
      Insertion_cost:= dp_matrix[j,i−1] + B[i]
      Deletion_cost:= dp_matrix[j−1,i] + A[j]
      Substitution_cost:= dp_matrix[j−1,i−1] + |A[i]−B[j]|
      dp_matrix[j,i]=min(Insertion_cost,Deletion_cost,
    Substitution_cost)
  dist:= dp_matrix[num_of_bands,num_of_bands]
Return
  dist
```

The pseudo code for the Hungarian method is provided below

### Inputs:

Band_Wavelengths, Spectrum A, Spectrum B, param a, param A

### Initialization:

dist:=0

dist_matrix=empty_matrix(shape=(num_of_bands, num_of_bands))

### Algorithm:

```
  for each channel i in Band_Wavelengths:
    for each channel j in Band_Wavelengths:
      band_dif:=|Band_Wavelengths[i]−Band_Wavelengths[j]|
      temp:= λ·band_dif + |A[i]−B[j]|
      dist_matrix[i,j] = σ·temp
  assigns:= Hungarian_optimal_assignments(dist_matrix)
  For each assignment a in assigns:
    dist = dist + dist_matrix[a]
  Return
    dist
```

The pseudo code for the piece-wise angle and length method is provided below

### Inputs:

Band_Wavelengths, Spectrum A, Spectrum B, Param A

### Initialization:

dist:=0

### Algorithm:

```
For each pair of consecutive channels i and i+1 in Band_wavelengths:
  Band_diff:=Band_Wavelengths[i+1]−Band_Wavelengths[i]
  angleA:= arctan((A[i+1]−A[i])/Band_diff)
  angleB:= arctan((B[i+1]−B[i])/Band_diff)
  angle:= |angleA − angleB|
  if(angle > 2π):
    angle = 2π − angle
  lengthA = sqrt((A[i+1]−A[i])² + Band_diff²)
  lengthB = sqrt((B[i+1]−B[i])² + Band_diff²)
  length = |lengthA − lengthB|
  dist = dist + [λ·angle + length]
  Return
    Dist
```

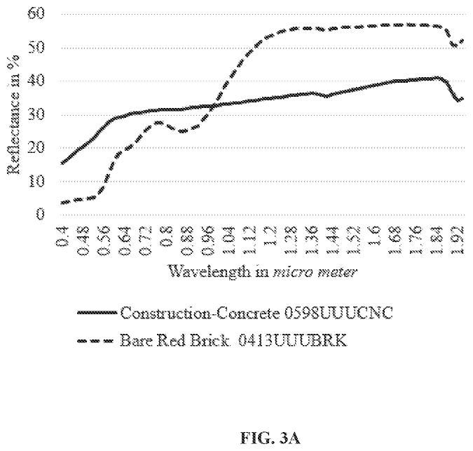

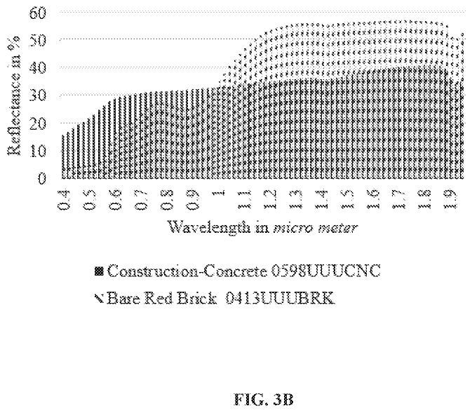

FIG. 3A depicts a graphical representation of an example of spectral signatures in line graph according to some embodiments of the present disclosure. The figure shows the line graph of the spectral signatures of construction concrete and red brick.

FIG. 3B depicts a graphical representation of an example of spectral signatures in bar chart according to some embodiments of the present disclosure. The figure shows a bar chart view of the spectral signatures of construction concrete and red brick.

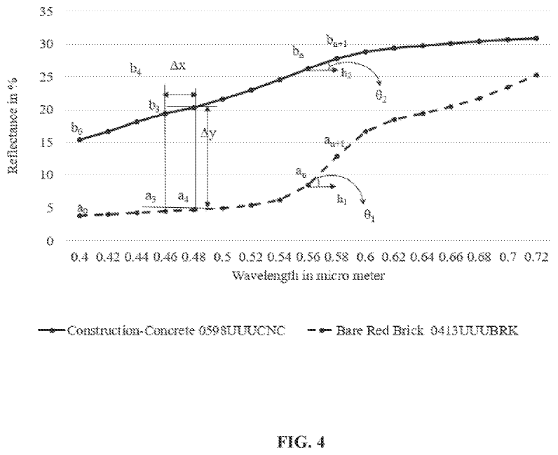

FIG. 4 depicts a graphical representation of an example showing transformation steps for spectrum matching according to some embodiments of the present disclosure. As an example, the spectral signatures for “Construction concrete” and “Bare brick red” are shown in the figure. They are represented as arc of points {a₀ to aₙ} and {b₀ to bₙ}. The transformation of point a₀ to its corresponding point on the second arc, which could be any point in {b₀ to bₙ} and incurs a cost. For example, the cost of translation in x and y direction are given as Δx and Δy. In case the spectra do not have same number of bands then inserting and deleting the point or bar is considered. For the piece wise angle and length distance, the Δθ={θ₁ and θ₂}, and ΔL=len(arc(aₙ, aₙ₊₁))−len(arc(bₙ, bₙ₊₁)) is calculated and then added, that is Δθ+ΔL. Total distance is sum of this for each corresponding arc from two spectra.

In an embodiment of the present disclosure, the one or more processors 102 are configured to obtain at step 208, a set of global transformation costs by taking the sum of transformation cost corresponding to each optimal transformation of the set of optimal transformations. The set of global transformation cost is the sum of (costs for) optimal pairs of primitives of the target spectrum and the reference spectrum. The best pair of transformation for each primitive cannot be decided using the local minima.

In an embodiment of the present disclosure, the one or more processors 102 are configured to obtain at step 210, an optimal transformation cost by optimizing the set of global transformation costs using an optimization technique, wherein the optimal transformation cost represents the optimal spectrum matching of the target spectrum with the reference spectrum. Optimization is performed using any suitable optimization method such as dynamic programming method or the Hungarian method for calculating the best matching score between the target spectrum and the reference spectrum. Higher the matching score better is the discrimination between the two spectra. The score can be inversed to convert it to a similarity score where high score indicates a good match.

EXPERIMENTAL RESULTS: The performance of the disclosed method on spectral databases available in public domain are analyzed. Publicly available spectral libraries such as ASTER, splib07, and splib Tarnag are used for analyzing the performance of the disclosed method. Spectra of most representative materials in each Visible Spectroscopy (VIS) categories were selected. For example, three number of samples from vegetation, impervious surfaces (such as concrete, asphalt etc.), and soil are selected. The code of the materials as per the library nomenclature is provided in the table for easy reference. The original spectral spectra were resampled to a common wavelength range by a simple interpolation. The new range was different for spib07 and ASTER library. It is <from-to-interval> for splib07 and <from-to-interval> for ASTER. This is not essential as the disclosed method do not require two vectors of same length for distance calculation. However, it is essential for comparative assent with the other methods. Table 2, Table 3, and Table 4 shows a comparison of distances of the edit distance based method, the Hungarian based method and the piece-wise angular distance method respectively for various spectral signatures.

TABLE 2
Edit distance based method

| | | Light | |
|---|---|---|---|
| | Construction- | yellowish | Ficus |
| | Concrete | brown clay- | Platypoda- |
| | 0598UUUCNC | 89p1763 | JPL194 |
| Asphalt- | 784.95 | 1954.552 | 1234.993 |
| Shingle | | | |
| 0490UUUASP | | | |
| Bare Red | 987.46 | 720.2227 | 978.323 |
| Brick | | | |
| 0413UUUBRK | | | |
| Black Tar | 323.67 | 323.67 | 323.67 |
| Paper | | | |
| 0522UUUTAR | | | |
| Construction- | 715.55 | 715.55 | 689.903 |
| Asphalt | | | |
| 0674UUUASP | | | |
| Construction- | 0 | 1317.757 | 1105.231 |
| Concrete | | | |
| 0598UUUCNC | | | |
| Galvanised- | 948.03 | 949.83 | 714.457 |
| Steel-Metal | | | |
| 0525UUUSTLa | | | |
| Olive-Green- | 2039.118 | 1045.346 | 1257.283 |
| Paint | | | |
| 0407UUUPNT | | | |

TABLE 3
Hungarian based method

| | | Light | |
|---|---|---|---|
| | Construction- | yellowish | Ficus |
| | Concrete | brown clay- | Platypoda |
| | 0598UUUCNC | 89p1763 | JPL194 |
| Asphalt- | 679.03 | 1981.145 | 1106.259 |
| Shingle | | | |
| 0490UUUASP | | | |
| Bare Red | 1072.71 | 834.2591 | 639.673 |
| Brick | | | |
| 0413UUUBRK | | | |
| Black Tar | 2360.2 | 3675.882 | 2346.437 |
| Paper | | | |
| 0522UUUTAR | | | |
| Construction- | 1968.32 | 3284.002 | 1954.557 |
| Asphalt | | | |
| 0674UUUASP | | | |
| Construction- | 0 | 1317.757 | 952.419 |
| Concrete | | | |
| 0598UUUCNC | | | |
| Galvanised- | 1734.04 | 3049.722 | 1725.077 |
| Steel-Metal | | | |
| 0525UUUSTLa | | | |
| Olive-Green- | 2039.118 | 1141.948 | 1637.299 |
| Paint | | | |
| 0407UUUPNT | | | |

TABLE 4
Piece-wise angular distance method

| | | Light | |
|---|---|---|---|
| | Construction- | yellowish | Ficus |
| | Concrete | brown clay- | Platypoda |
| | 0598UUUCNC | 89p1763 | JPL194 |
| Asphalt- | 905.4136 | 2032.025 | 1331.455 |
| Shingle | | | |
| 0490UUUASP | | | |
| Bare Red | 1074.922 | 920.2697 | 1527.821 |
| Brick | | | |
| 0413UUUBRK | | | |
| Black Tar | 2387.787 | 3664.107 | 2302.735 |
| Paper | | | |
| 0522UUUTAR | | | |
| Construction- | 2006.092 | 3268.659 | 1915.444 |
| Asphalt | | | |
| 0674UUUASP | | | |
| Construction- | 0 | 1329.037 | 1212.507 |
| Concrete | | | |
| 0598UUUCNC | | | |
| Galvanised- | 1788.041 | 3022.219 | 1755.362 |
| Steel-Metal | | | |
| 0525UUUSTLa | | | |
| Olive-Green- | 2092.148 | 1253.861 | 1779.658 |
| Paint | | | |
| 0407UUUPNT | | | |

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method comprising:
receiving, via one or more hardware processors, a target spectrum of a target object for performing an optimal spectrum matching with a reference spectrum, wherein the target spectrum comprises a first set of primitives and the reference spectrum comprises a second set of primitives represented in a two-dimensional space;
transforming, via the one or more hardware processors, each primitive in the first set of primitives of the target spectrum to at least one primitive in the second set of primitives of the reference spectrum using at least one of a first transformation method, a second transformation method and a third transformation method to obtain a set of transformations, wherein each transformation in the set of transformations incurs a transformation cost;
obtaining, via the one or more hardware processors, a set of optimal transformations of the first set of primitives to the second set of primitives by optimizing the set of transformations;
obtaining, via the one or more hardware processors, a set of global transformation costs by taking the sum of transformation cost corresponding to each optimal transformation of the set of optimal transformations; and
obtaining, via the one or more hardware processors, an optimal transformation cost by optimizing the set of global transformation costs using an optimization technique, wherein the optimal transformation cost represents the optimal spectrum matching of the target spectrum with the reference spectrum.

2. The method of claim 1, wherein the target spectrum and the reference spectrum are at least one of a hyperspectral spectrum or a multispectral spectrum.

3. The method of claim 1, wherein the first transformation method corresponds to an edit distance based method based on a distance measured between the first set of primitives and the second set of primitives.

4. The method of claim 1, wherein the second transformation method corresponds to a Hungarian based method based on x and y dimension distance measure between the first set of primitives and the second set of primitives.

5. The method of claim 1, wherein the third transformation method corresponds to a piece-wise angular distance method based on angular difference and length difference between the first set of primitives and the second set of primitives.

6. The method of claim 1, wherein the transformation cost corresponds to one or more of (i) translation of a primitive in x and y dimensions (ii) deletion of the primitive and (iii) insertion of the primitive.

7. A system, comprising:
a memory storing instructions;
one or more communication interfaces; and
one or more hardware processors coupled to the memory via the one or more communication interfaces, wherein the one or more hardware processors are configured by the instructions to:
receive a target spectrum of a target object for performing an optimal spectrum matching with a reference spectrum, wherein the target spectrum comprises a first set of primitives and the reference spectrum comprises a second set of primitives represented in a two-dimensional space;
transform each primitive in the first set of primitives of the target spectrum to at least one primitive in the second set of primitives of the reference spectrum using at least one of a first transformation method, a second transformation method and a third transformation method to obtain a set of transformations, wherein each transformation in the set of transformations incurs a transformation cost;
obtain a set of optimal transformations of the first set of primitives to the second set of primitives by optimizing the set of transformations;
obtain a set of global transformation costs by taking the sum of transformation cost corresponding to each optimal transformation of the set of optimal transformations; and
obtain an optimal transformation cost by optimizing the set of global transformation costs using an optimization technique, wherein the optimal transformation cost represents the optimal spectrum matching of the target spectrum with the reference spectrum.

8. The system of claim 7, wherein the target spectrum and the reference spectrum are at least one of a hyperspectral spectrum or a multispectral spectrum.

9. The system of claim 7, wherein the first transformation method corresponds to an edit distance based method based on a distance measured between the first set of primitives and the second set of primitives.

10. The system of claim 7, wherein the second transformation method corresponds to a Hungarian based method based on x and y dimension distance measure between the first set of primitives and the second set of primitives.

11. The system of claim 7, wherein the third transformation method corresponds to a piece-wise angular distance method based on angular difference and length difference between the first set of primitives and the second set of primitives.

12. The system of claim 7, wherein the transformation cost corresponds to one or more of (i) translation of a primitive in x and y dimensions (ii) deletion of the primitive and (iii) insertion of the primitive.

13. One or more non-transitory machine-readable information storage mediums comprising one or more instructions which when executed by one or more hardware processors cause:
receiving, a target spectrum of a target object for performing an optimal spectrum matching with a reference spectrum, wherein the target spectrum comprises a first set of primitives and the reference spectrum comprises a second set of primitives represented in a two-dimensional space;
transforming, via the one or more hardware processors, each primitive in the first set of primitives of the target spectrum to at least one primitive in the second set of primitives of the reference spectrum using at least one of a first transformation method, a second transformation method and a third transformation method to obtain a set of transformations, wherein each transformation in the set of transformations incurs a transformation cost;
obtaining, via the one or more hardware processors, a set of optimal transformations of the first set of primitives to the second set of primitives by optimizing the set of transformations;
obtaining, via the one or more hardware processors, a set of global transformation costs by taking the sum of transformation cost corresponding to each optimal transformation of the set of optimal transformations; and
obtaining, via the one or more hardware processors, an optimal transformation cost by optimizing the set of global transformation costs using an optimization technique, wherein the optimal transformation cost represents the optimal spectrum matching of the target spectrum with the reference spectrum.

14. The one or more non-transitory machine-readable information storage mediums of claim 13, wherein the target spectrum and the reference spectrum are at least one of a hyperspectral spectrum or a multispectral spectrum.

15. The one or more non-transitory machine-readable information storage mediums of claim 13, wherein the first transformation method corresponds to an edit distance based method based on a distance measured between the first set of primitives and the second set of primitives.

16. The one or more non-transitory machine-readable information storage mediums of claim 13, wherein the second transformation method corresponds to a Hungarian based method based on x and y dimension distance measure between the first set of primitives and the second set of primitives.

17. The one or more non-transitory machine-readable information storage mediums of claim 13, wherein the third transformation method corresponds to a piece-wise angular distance method based on angular difference and length difference between the first set of primitives and the second set of primitives.

18. The one or more non-transitory machine-readable information storage mediums of claim 13, wherein the transformation cost corresponds to one or more of (i) translation of a primitive in x and y dimensions (ii) deletion of the primitive and (iii) insertion of the primitive.
